(19) United States
(12) Patent Application Publication
(10) Pub. No.: US 2017/0341854 A1
(43) Pub. Date: Nov. 30, 2017

(54) PACKAGE OF POROUS SEPARATOR ROLL, METHOD FOR PRODUCING THE SAME, AND METHOD FOR STORING POROUS SEPARATOR ROLL

(71) Applicant: Sumitomo Chemical Company, Limited, Tokyo (JP)

(72) Inventors: Daizaburo YASHIKI, Niihama-shi (JP); Takahiro OKUGAWA, Niihama-shi (JP)

(21) Appl. No.: 15/603,613

(22) Filed: May 24, 2017

(30) Foreign Application Priority Data
May 26, 2016 (JP) 2016-105234

(51) Int. Cl. B65D 85/672; H01M 2/16; B65H 18/28; B65D 65/16; B65B 63/04; H01M 2/18; B65B 11/00

(52) U.S. Cl. CPC B65D 85/672; H01M 2/18; H01M 2/1686; H01M 2/1653; B65B 11/00; B65D 65/16; B65B 63/04; B65H 18/28

(57) ABSTRACT

In the present invention, a porous separator roll (12U, 12L) is wrapped with a wrapping material (21) whose average transmittance with respect to light having a wavelength of 360 nm to 390 nm is 25% or lower. From this, it is possible to provide a package of a porous separator roll which package can inhibit change in color of a separator, and can thus provide a high-quality separator with good appearance.

This Nonprovisional application claims priority under 35 U.S.C. §119 on Patent Application No. 2016-105234 filed in Japan on May 26, 2016, the entire contents of which is hereby incorporated by reference.

### TECHNICAL FIELD

The present invention relates to a package of a porous separator roll in which package a porous separator roll is wrapped with a wrapping material. Here, the porous separator roll is a roll obtained by winding, on a core, a porous long separator sheet which is used in a battery such as a lithium-ion battery.

### BACKGROUND ART

A separator original sheet used in a lithium-ion battery is slit (cut) in a machine direction of the original sheet, and thus a plurality of long separator sheets are obtained each of which has a predetermined width in a direction perpendicular to the machine direction. Each of the plurality of long separator sheets is wound on a core and is then supplied to a battery production process as a separator roll. In the battery production process, each of the plurality of long separator sheets is cut in a predetermined length in a direction perpendicular to the machine direction, and is thus used as a separator.

Patent Literature 1 discloses a method for storing and transporting separator rolls which are obtained as above described.

### CITATION LIST

### Patent Literature

[Patent Literature 1]

Japanese utility model registration No. 3194816 (Publication Date: Dec. 11, 2014)

### SUMMARY OF INVENTION

### Technical Problem

However, in a case where the separator roll is exposed to light in an ultraviolet region (hereinafter, referred to as “UV light”) while being stored or the like, a color of the separator roll may change and this causes deterioration in quality of the separator roll.

### Solution to Problem

In order to attain the object, in the package of a porous separator roll in accordance with an aspect of the present invention, the porous separator roll which is obtained by winding a porous long separator sheet on a core is wrapped with a wrapping material whose average transmittance with respect to light having a wavelength of 360 nm to 390 nm is 25% or lower.

According to the configuration, it is possible to inhibit change in color of the porous long separator sheet.

The method for producing a package of a porous separator roll in accordance with an aspect of the present invention includes the step of wrapping the porous separator roll, which is obtained by winding a porous long separator sheet on a core, with a wrapping material whose average transmittance with respect to light having a wavelength of 360 nm to 390 nm is 25% or lower.

According to the method, it is possible to produce a package of a porous separator roll that can inhibit change in color, deterioration, and the like of the porous long separator sheet included in the porous separator roll.

### Advantageous Effects of Invention

According to an aspect of the present invention, it is possible to inhibit change in color of a porous separator roll.

### BRIEF DESCRIPTION OF DRAWINGS

FIG. 1 is a schematic view illustrating a cross sectional configuration of a lithium-ion secondary battery.

FIG. 2 is a schematic view illustrating details of the configuration of the lithium-ion secondary battery illustrated in FIG. 1.

FIG. 3 is a schematic view illustrating another configuration of the lithium-ion secondary battery illustrated in FIG. 1.

(a) of FIG. 4 is a schematic view illustrating a configuration of a slitting apparatus for slitting a separator original sheet, and (b) of FIG. 4 is a view illustrating a state in which the separator original sheet is slit into a plurality of long separator sheets by the slitting apparatus.

(a) of FIG. 5 is a view illustrating a porous separator roll of a porous long separator sheet having an outer peripheral surface to which a seal (film material) is attached. (b) of FIG. 5 is a view illustrating a package of a porous separator roll which is wrapped with a wrapping material. (c) of FIG. 5 is a view illustrating a package in which a rack and a porous separator roll placed on the rack are wrapped with a wrapping material.

FIG. 6 is a view showing transmittances of various wrapping materials and a polyolefin porous base material.

FIG. 7 is a view showing a degree of color change caused by irradiating, with UV light, a porous layer in a long separator sheet of a porous separator roll which is wrapped with each of various wrapping materials.

FIG. 8 is a view showing a degree of color change caused by irradiating, with UV light, a porous layer in a laminated long separator sheet of a porous separator roll which is wrapped with each of other various wrapping materials.

(a) of FIG. 9 is a view showing a relation between a value of WI of a porous layer and an absorbance of a wrapping material in each of samples. (b) of FIG. 9 is a view showing a relation between a value of WI of a porous layer and a transmittance of a wrapping material in each of samples.

(a) of FIG. 10 is a view showing a relation between a value of YI of a porous layer and an absorbance of a wrapping material in each of samples. (b) of FIG. 10 is a view showing a relation between a value of YI of a porous layer and a transmittance of a wrapping material in each of samples.

### DESCRIPTION OF EMBODIMENTS

[Basic Configuration]

The following description will discuss in order a lithium-ion secondary battery, a separator, a laminated separator, and a method for producing the laminated separator.

(Lithium-Ion Secondary Battery)

A nonaqueous electrolyte secondary battery, typically, a lithium-ion secondary battery has a high energy density, and is therefore currently widely used not only as batteries for use in devices such as personal computers, mobile phones, and mobile information terminals, and for use in moving bodies such as automobiles and airplanes, but also as stationary batteries contributing to stable power supply.

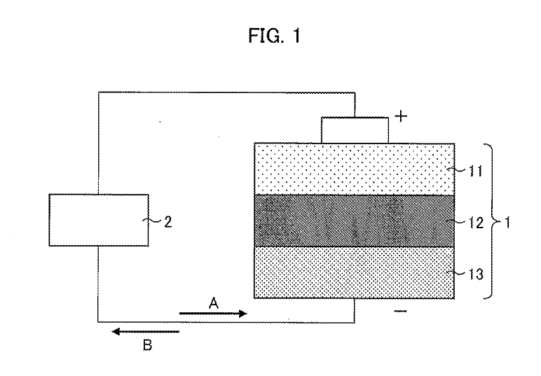

FIG. 1 is a schematic view illustrating a cross sectional configuration of a lithium-ion secondary battery 1.

As illustrated in FIG. 1, the lithium-ion secondary battery 1 includes a cathode 11, a separator 12, and an anode 13. Between the cathode 11 and the anode 13, an external device 2 is connected outside the lithium-ion secondary battery 1. While the lithium-ion secondary battery 1 is being charged, electrons move in a direction A. On the other hand, while the lithium-ion secondary battery 1 is being discharged, electrons move in a direction B.

(Separator)

The separator 12 is provided so as to be sandwiched between the cathode 11 which is a positive electrode of the lithium-ion secondary battery 1 and the anode 13 which is a negative electrode of the lithium-ion secondary battery 1. The separator 12 is a porous film that separates the cathode 11 and the anode 13, allowing lithium ions to move between the cathode 11 and the anode 13. The separator 12 contains, for example, polyolefin such as polyethylene or polypropylene as a material, and is called “polyolefin porous base material”.

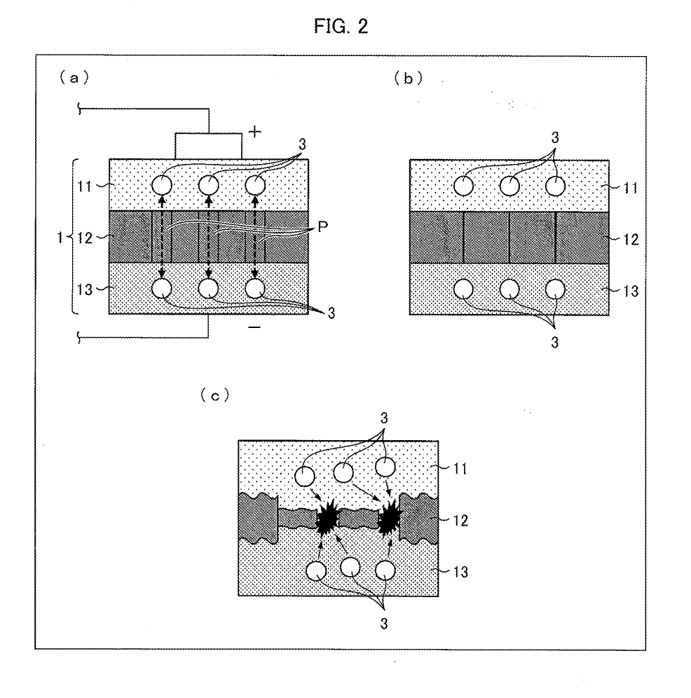

FIG. 2 is a schematic view illustrating details of the configuration of the lithium-ion secondary battery 1 illustrated in FIG. 1. (a) of FIG. 2 illustrates a normal configuration. (b) of FIG. 2 illustrates a state in which a temperature of the lithium-ion secondary battery 1 has risen. (c) of FIG. 2 illustrates a state in which a temperature of the lithium-ion secondary battery 1 has sharply risen.

As illustrated in (a) of FIG. 2, the separator 12 is provided with many pores P. Normally, lithium ions 3 in the lithium-ion secondary battery 1 can move back and forth through the pores P.

Here, there are, for example, cases in which the temperature of the lithium-ion secondary battery 1 rises due to excessive charging of the lithium-ion secondary battery 1, a high current caused by short-circuiting of the external device, or the like. In such cases, the separator 12 melts or softens and the pores P are blocked as illustrated in (b) of FIG. 2. As a result, the separator 12 shrinks. This stops the movement of the lithium ions 3, and consequently stops the above described temperature rise.

However, in a case where a temperature of the lithium-ion secondary battery 1 sharply rises, the separator 12 suddenly shrinks. In this case, as illustrated in (c) of FIG. 2, the separator 12 may be destroyed. Then, the lithium ions 3 leak out from the separator 12 which has been destroyed. As a result, the lithium ions 3 do not stop moving. Consequently, the temperature continues rising.

(Heat-Resistant Separator)

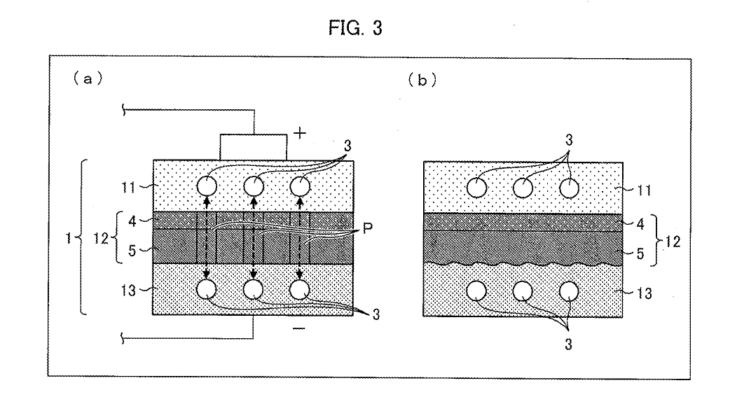

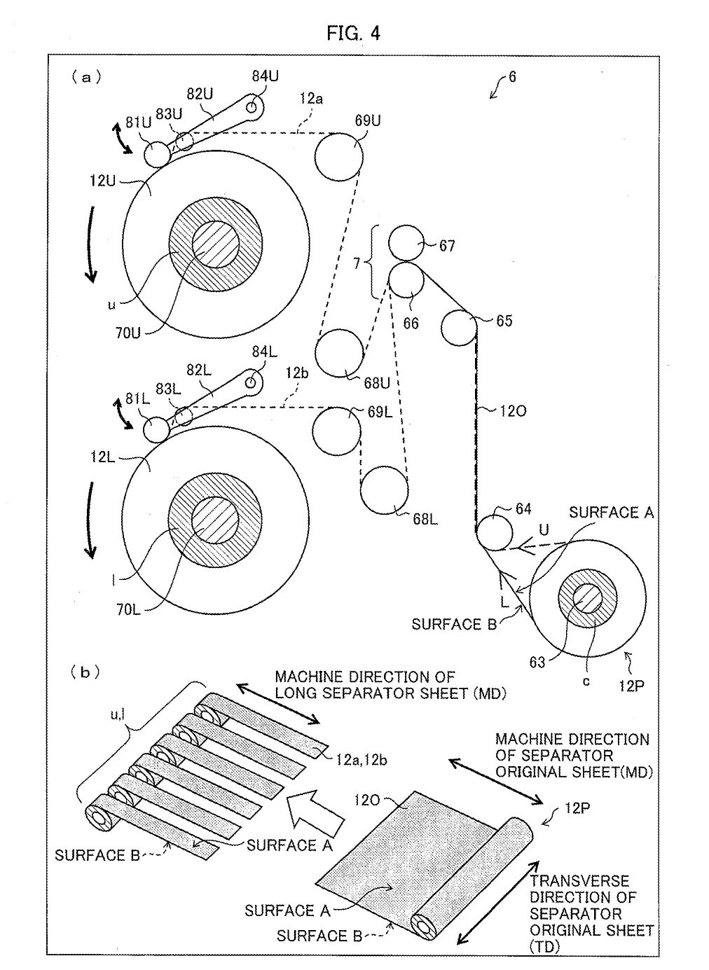

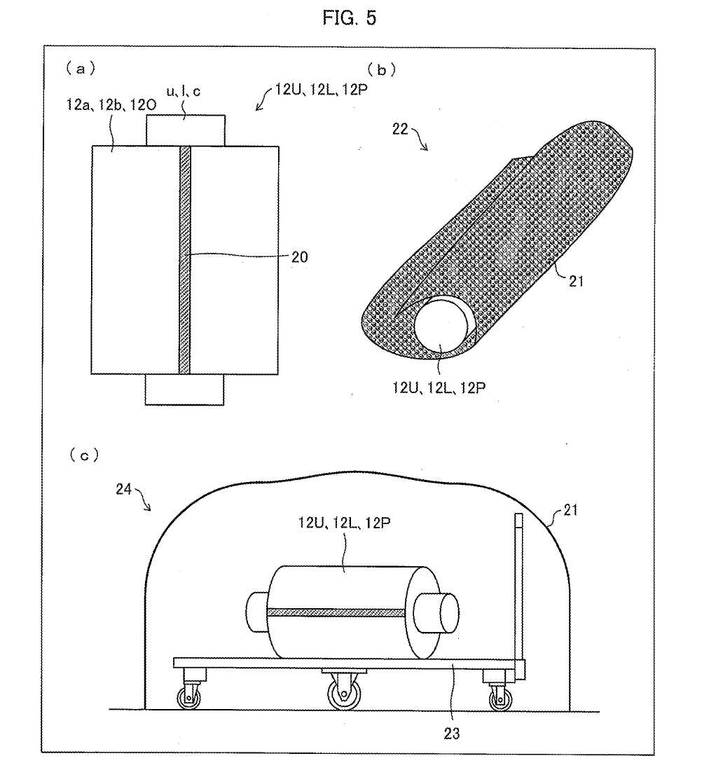

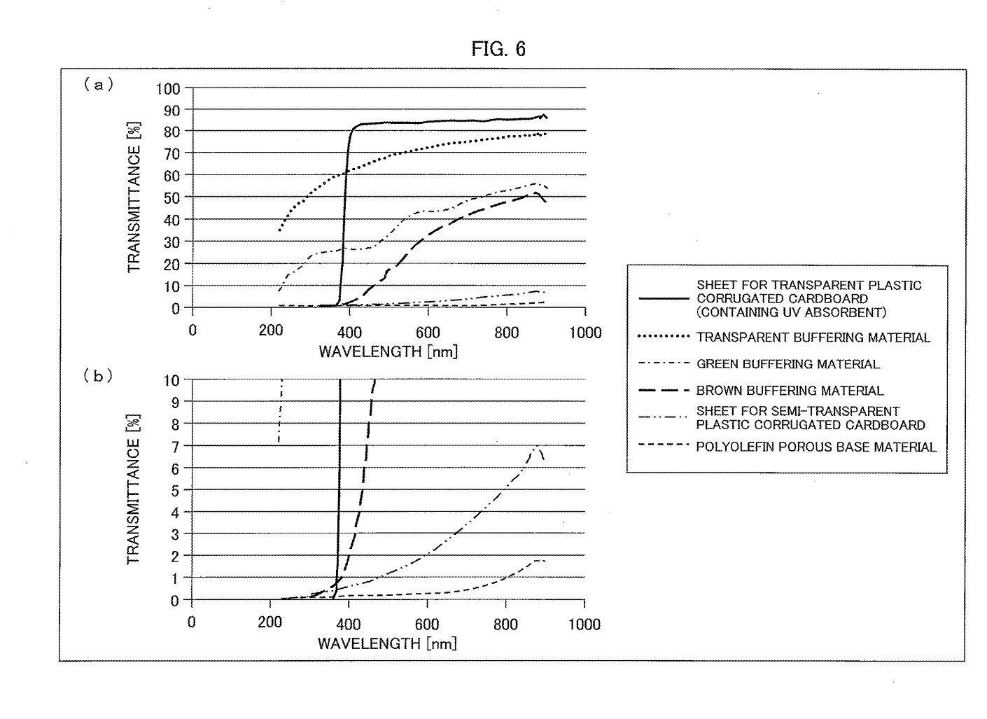

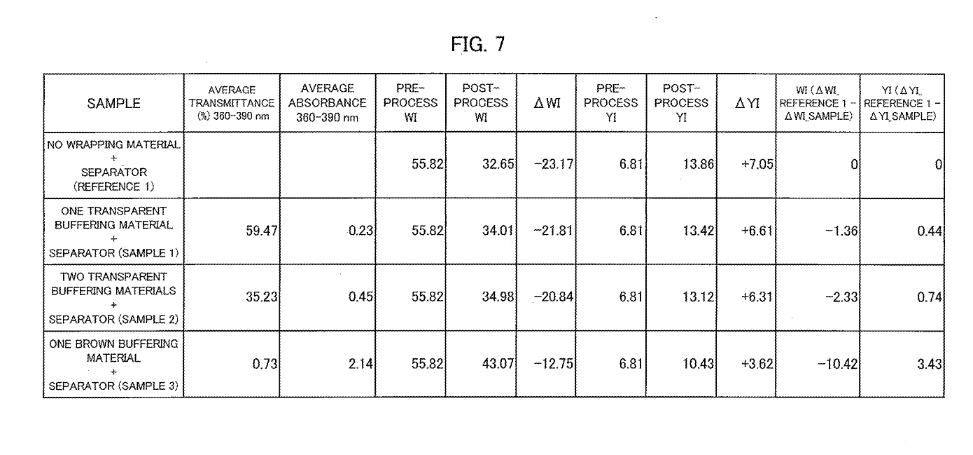

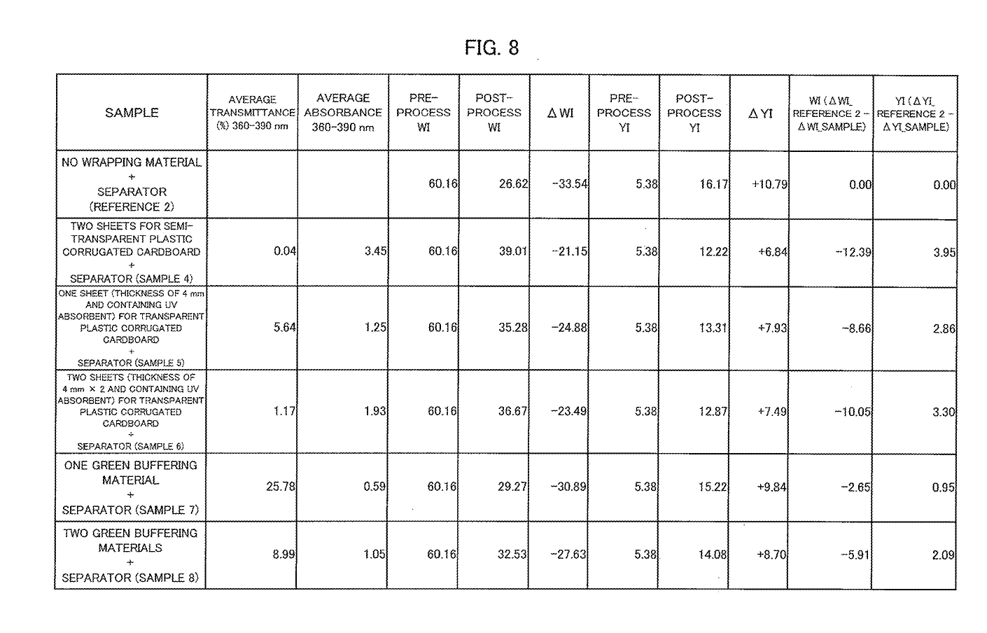

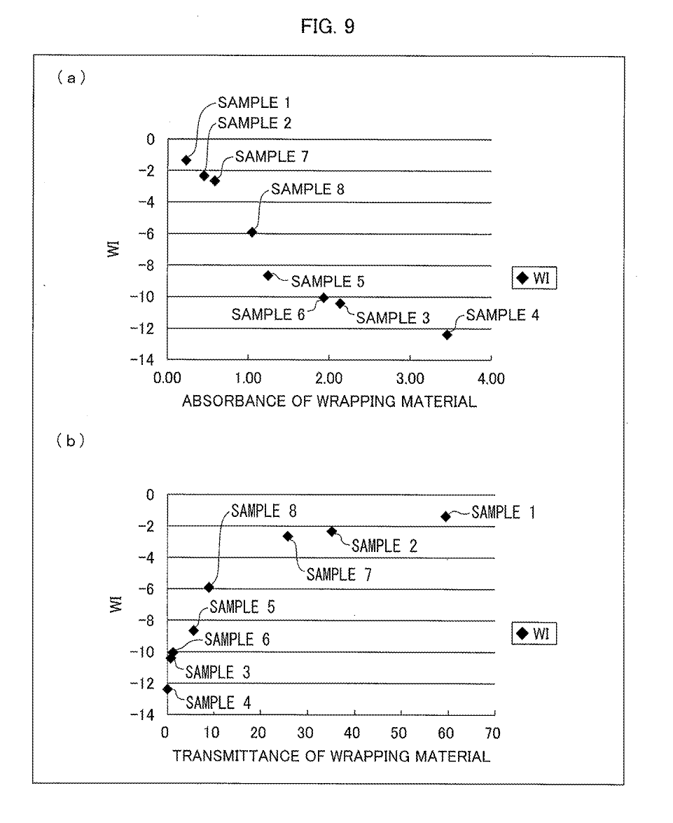

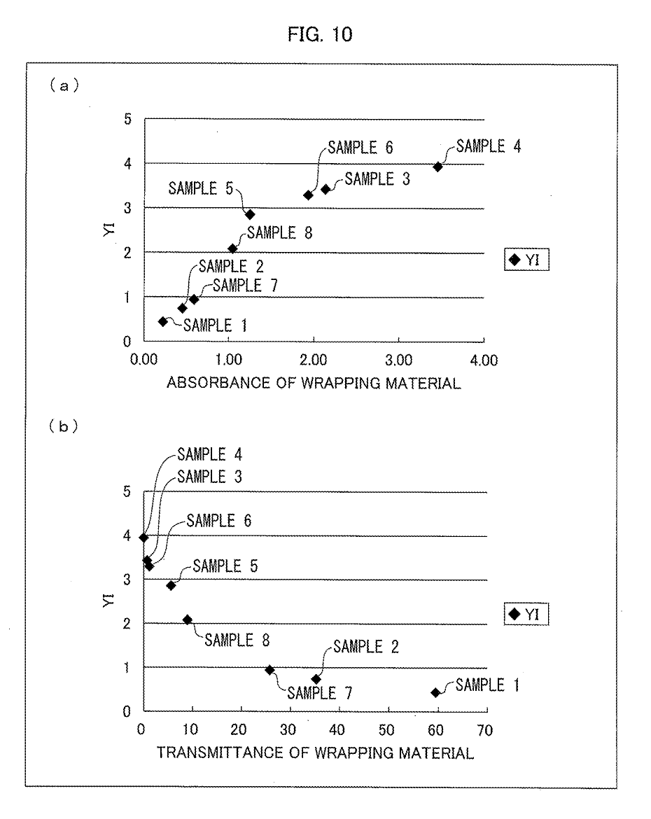

FIG. 3 is a schematic view illustrating another configuration of the lithium-ion secondary battery 1 illustrated in FIG. 1. (a) of FIG. 3 illustrates a normal configuration, and (b) of FIG. 3 illustrates a state in which a temperature of the lithium-ion secondary battery 1 has sharply risen.

As illustrated in (a) of FIG. 3, the separator 12 can be a heat-resistant separator that includes a porous film 5 (e.g., a polyolefin porous base material) and a heat-resistant layer 4. The heat-resistant layer 4 is laminated on a surface of the porous film 5 which surface is on a cathode 11 side. Note that the heat-resistant layer 4 can alternatively be laminated on a surface of the porous film 5 which surface is on an anode 13 side, or both surfaces of the porous film 5. Further, the heat-resistant layer 4 is provided with pores which are similar to the pores P. Normally, the lithium ions 3 move through the pores P and the pores of the heat-resistant layer 4. The heat-resistant layer 4 contains, for example, wholly aromatic polyamide (aramid resin) which is an aromatic polymer as a material.

As illustrated in (b) of FIG. 3, even in a case where the temperature of the lithium-ion secondary battery 1 sharply rises and, as a result, the porous film 5 melts or softens, the shape of the porous film 5 is maintained because the heat-resistant layer 4 supports the porous film 5. Therefore, such a sharp temperature rise results in only melting or softening of the porous film 5 and consequent blocking of the pores P. This stops movement of the lithium ions 3 and consequently stops the above-described excessive discharging or excessive charging. In this way, the separator 12 can be prevented from being destroyed.

(Laminated Separator)

The heat-resistant separator which includes the heat-resistant layer 4 illustrated in FIG. 3 is classified into a laminated separator. Examples of other laminated separator encompass a laminated separator which includes a porous layer such as an adhesive layer or a protective layer, instead of the heat-resistant layer 4.

Examples of resin of which the porous layer such as the heat-resistant layer 4, the adhesive layer, or the protective layer is made encompass: polyolefins such as polyethylene, polypropylene, polybutene, and an ethylene-propylene copolymer; fluorine-containing resins such as polyvinylidene fluoride (PVDF), polytetrafluoroethylene, a vinylidene fluoride-hexafluoropropylene-tetrafluoroethylene copolymer, and an ethylene-tetrafluoroethylene copolymer; aromatic polyamide; wholly aromatic polyamide (aramid resin); rubbers such as a styrene-butadiene copolymer and a hydride thereof, a methacrylate ester copolymer, an acrylonitrile-acrylic ester copolymer, a styrene-acrylic ester copolymer, ethylene propylene rubber, and polyvinyl acetate; resins having a melting point or a glass transition temperature of not lower than 180° C., such as polyphenylene ether, polysulfone, polyether sulfone, polyphenylene sulfide, polyetherimide, polyamide imide, polyether amide, and polyester; water-soluble polymers such as polyvinyl alcohol, polyethylene glycol, cellulose ether, sodium alginate, polyacrylic acid, polyacrylamide, and polymethacrylic acid; and the like.

Among those, resins having a n bonding or halogen atoms are more likely to cause change in color by being exposed to UV light, and therefore a laminated separator which includes a porous layer containing any of those resins tends to bring about the effect of the present invention more notably. Examples of the resins having a n bonding or halogen atoms encompass a polymer containing halogen atoms such as a fluorine-containing resin; and an aromatic polymer such as aromatic polyamide. Examples of the fluorine-containing resin encompass polyvinylidene fluoride (PVDF), polytetrafluoroethylene, a vinylidene fluoride-hexafluoropropylene-tetrafluoroethylene copolymer, an ethylene-tetrafluoroethylene copolymer, and the like. Examples of the aromatic polymer encompass wholly aromatic polyamide (aramid resin), polyphenylene ether, polysulfone, polyether sulfone, polyphenylene sulfide, polyetherimide, polyamide imide, polyether amide, polyester, and the like. Examples of the resin having a n bonding encompass a styrene-butadiene copolymer and a hydride thereof; a styrene copolymer such as a styrene-acrylic ester copolymer; acrylic polymers such as acrylic ester, methacrylic ester, a methacrylic ester-acrylic ester copolymer, a styrene-acrylic ester copolymer, and an acrylonitrile-acrylic ester copolymer; conjugated diene polymers such as an acrylonitrile-butadiene copolymer and a hydride thereof, and an acrylonitrile-butadiene-styrene copolymer and a hydride thereof; polymers having a cyano group such as cyanoethyl pullulan, cyanoethyl polyvinyl alcohol, cyanoethyl cellulose, and cyanoethyl sucrose; and the like.

The porous layer can contain a filler. The filler, which is not particularly limited to any specific filler, can be a filler made of an organic matter or a filler made of an inorganic matter.

Specific examples of the filler made of an organic matter encompass fillers made of (i) a homopolymer of a monomer such as styrene, vinyl ketone, acrylonitrile, methyl methacrylate, ethyl methacrylate, glycidyl methacrylate, glycidyl acrylate, or methyl acrylate, or (ii) a copolymer of two or more of such monomers; fluorine-containing resins such as polytetrafluoroethylene, an ethylene tetrafluoride-propylene hexafluoride copolymer, a tetrafluoroethylene-ethylene copolymer, and polyvinylidene fluoride; melamine resin; urea resin; polyethylene; polypropylene; polyacrylic acid and polymethacrylic acid; and the like.

Specific examples of the filler made of an inorganic matter encompass fillers made of inorganic matters such as calcium carbonate, talc, clay, kaolin, silica, hydrotalcite, diatomaceous earth, magnesium carbonate, barium carbonate, calcium sulfate, magnesium sulfate, barium sulfate, aluminum hydroxide, boehmite, magnesium hydroxide, calcium oxide, magnesium oxide, titanium oxide, titanium nitride, alumina (aluminum oxide), aluminum nitride, mica, zeolite, and glass. The porous layer can contain (i) only one kind of filler or (ii) two or more kinds of fillers in combination.

Among the above fillers, a filler made of an inorganic matter is suitable. A filler made of an inorganic oxide such as silica, calcium oxide, magnesium oxide, titanium oxide, alumina, mica, zeolite, aluminum hydroxide, or boehmite is more preferable. A filler made of at least one kind selected from the group consisting of silica, magnesium oxide, titanium oxide, aluminum hydroxide, boehmite, and alumina is further preferable.

(Production Steps of Heat-Resistant Separator which is Laminated Separator)

How to produce the heat-resistant separator of the lithium-ion secondary battery 1 is not specifically limited. The heat-resistant separator can be produced by a publicly known method. The following discussion assumes a case where the porous film 5 contains polyethylene as a main material. However, even in a case where the porous film 5 contains another material, the similar steps can still be applied to production of the separator 12.

For example, it is possible to employ a method including the steps of first forming a film by adding a pore forming agent to a thermoplastic resin, and then removing the pore forming agent with an appropriate solvent. For example, in a case where the porous film 5 is made of a polyethylene resin containing ultra-high molecular weight polyethylene, it is possible to produce the porous film 5 by the following method.

This method includes (1) a kneading step of obtaining a polyethylene resin composition by kneading ultra-high molecular weight polyethylene and a pore forming agent such as calcium carbonate or liquid paraffin, (2) a rolling step of forming a film with the polyethylene resin composition, (3) a removal step of removing the pore forming agent from the film obtained in the step (2), and (4) a stretching step of obtaining the porous film 5 by stretching the film obtained in the step (3).

In the removal step, many fine pores are provided in the film. The fine pores of the film stretched in the stretching step become the above-described pores P. The porous film 5 formed as a result is a polyethylene microporous film having a predetermined thickness and a predetermined air permeability.

Note that, in the kneading step, 100 parts by weight of the ultra-high molecular weight polyethylene, 5 parts by weight to 200 parts by weight of a low molecular weight polyolefin having a weight-average molecular weight of 10000 or less, and 100 parts by weight to 400 parts by weight of an inorganic filler can be kneaded.

Subsequently, in a coating step, the heat-resistant layer 4 is formed on a surface of the porous film 5. For example, on the porous film 5, an aramid/N-methyl-pyrrolidone (NMP) solution (coating solution) is applied, and thereby the heat-resistant layer 4 that is an aramid heat-resistant layer is formed. The heat-resistant layer 4 can be provided on only one surface or both surfaces of the porous film 5. Alternatively, for coating, the heat-resistant layer 4 can be formed by using a mixed solution containing a filler such as alumina/carboxymethyl cellulose.

A method for coating the porous film 5 with a coating solution is not specifically limited as long as uniform wet coating can be carried out by the method. The method can be a conventionally publicly known method such as a capillary coating method, a spin coating method, a slit die coating method, a spray coating method, a dip coating method, a roll coating method, a screen printing method, a flexo printing method, a bar coater method, a gravure coater method, or a die coater method. The heat-resistant layer 4 has a thickness which can be controlled by adjusting (i) a thickness of a coating wet film and (ii) a solid-content concentration in the coating solution.

Note that it is possible to use a resin film, a metal belt, a metal drum, or the like as a support with which the porous film 5 is fixed or transferred in coating.

As described above, it is possible to produce the separator 12 (heat-resistant separator) in which the heat-resistant layer 4 is laminated on the porous film 5. Thus produced separator is wound on a cylindrical core. Note that a subject to be produced by the above production method is not limited to the heat-resistant separator. The above production method does not necessarily include the coating step. In a case where the method includes no coating step, the subject to be produced is a separator including no heat-resistant layer.

### Embodiment 1

The heat-resistant separator or the separator including no heat-resistant layer (hereinafter, referred to as “separator”) preferably has a width (hereinafter, referred to as “product width”) suitable for application products such as the lithium-ion secondary battery 1. However, for improving productivity, the separator is produced so as to have a width that is equal to or larger than a product width. This is referred to as a separator original sheet. After the separator original sheet is once produced, the separator original sheet is cut (slit) by the slitting apparatus so that a “separator width” (which means a length in a direction substantially perpendicular to a machine direction and a thickness direction) of the separator original sheet becomes the product width, and thus a long separator sheet is obtained. In Embodiment 1, the long separator sheet is a separator which is longer in the machine direction. The configuration “longer in the machine direction” means that the separator has a length that is 5 m or longer in the machine direction. The long separator sheet preferably has a length of 5 m or longer and 10000 m or shorter.

In the following descriptions, a wide separator which is before being slit is referred to as “separator original sheet”, and a separator which has been slit so as to have a separator width that is the product width is particularly referred to as “long separator sheet”. Note that “slitting” means to slit the separator original sheet in the machine direction (i.e., a flow direction of the film during production; MD), and that “cutting” means to cut the long separator sheet in a transverse direction (TD). The “transverse direction (TD)” means a direction which is substantially perpendicular to the machine direction (MD) and the thickness direction of the long separator sheet.

(Porous Separator Roll)

(a) of FIG. 4 is a schematic view illustrating a configuration of a slitting apparatus 6 which includes a cutting device 7. (b) of FIG. 4 is a view illustrating a state in which the porous separator original sheet 12O is slit into a plurality of porous long separator sheets 12a and 12b by the slitting apparatus 6.

Embodiment 1 exemplifies the porous separator original sheet 12O in which a wholly aromatic polyamide (aramid resin layer) as the heat-resistant layer 4 is laminated on one surface of the porous film 5 (which is a polyolefin porous base material in Embodiment 1), as illustrated in FIG. 3. Note, however, that Embodiment 1 is not limited to this, and the porous separator original sheet 12O can be a porous film 5 on which no heat-resistant layer 4 is laminated or can be a sheet in which heat-resistant layers 4 are laminated on both surfaces of the porous film 5. Alternatively, the porous separator original sheet 12O can include a porous layer such as an adhesive layer or a protective layer, instead of the heat-resistant layer 4.

As illustrated in (a) of FIG. 4, the slitting apparatus 6 includes a wind-off roller 63 which is rotatably supported and has a cylindrical shape, rollers 64, 65, 68U, 68L, 69U, and 69L, a first touch roller 81U, a second touch roller 81L, a first arm 82U, a second arm 82L, a first take-up assisting roller 83U, a second take-up assisting roller 83L, a first winding-up roller 70U, a second winding-up roller 70L, and the cutting device 7.

In the slitting apparatus 6, a cylindrical core c is attached onto the wind-off roller 63, and the porous separator original sheet 12O is wound on the core c. The porous separator original sheet 12O is wound off from the core c along a route U or L. In a case where the porous separator original sheet 12O is to be transferred while a surface A of the porous separator original sheet 12O serves as an upper surface, the porous separator original sheet 12O is wound off along the route L. Whereas, in a case where the porous separator original sheet 12O is to be transferred while a surface B of the porous separator original sheet 12O serves as an upper surface, the porous separator original sheet 12O is wound off along the route U. Note that, in Embodiment 1, the porous separator original sheet 12O is transferred while the surface A serves as an upper surface, and therefore the porous separator original sheet 12O is wound off along the route L. Note that the porous long separator sheet 12O which has been wound into a roll is referred to as “porous separator roll 12P”.

In Embodiment 1, the surface A is a surface of the porous film 5 which surface is opposite to a surface making contact with the heat-resistant layer 4, and the surface B is a surface of the heat-resistant layer 4 which surface is opposite to a surface making contact with the porous film 5.

The porous separator original sheet 12O which has been thus wound off is transferred to the cutting device 7 via the roller 64 and the roller 65, and is then slit into a plurality of porous long separator sheets 12a and 12b by the cutting device 7 (see (a) and (b) of FIG. 4).

Among the plurality of porous long separator sheets 12a and 12b which have been slit by the cutting device 7, each of the long separator sheets 12a is transferred via the roller 68U, the roller 69U, and the first take-up assisting roller 83U, and is then wound on a cylindrical core u (bobbin) that is attached onto the first winding-up roller 70U (see (a) of FIG. 4). Moreover, each of the long separator sheets 12b among the plurality of porous long separator sheets 12a and 12b is transferred via the roller 68L, the roller 69L, and the second take-up assisting roller 83L, and is then wound on a cylindrical core 1 (bobbin) that is attached onto the second winding-up roller 70L. Note that the porous long separator sheets 12a and 12b which have been wound into rolls are referred to as “porous separator rolls 12U and 12L”.

In the porous separator rolls 12U and 12L, the porous long separator sheets 12a and 12b are wound so that the surface A of each of the porous long separator sheets 12a and 12b faces outside and the surface B of each of the porous long separator sheets 12a and 12b faces inside.

As such, it is possible to obtain an aramid long separator sheet as each of the porous long separator sheets 12a and 12b in which the porous film 5 and an aramid layer as the heat-resistant layer 4 are laminated. The aramid long separator sheets which are the porous long separator sheets 12a and 12b wound into rolls are referred to as “porous separator rolls 12U and 12L”.

(Package of Porous Separator Roll)

(a) of FIG. 5 is a view illustrating each of porous separator rolls 12U, 12L, and 12P into which the porous long separator sheet 12a or 12b or the porous separator original sheet 12O is wound, each having an outer peripheral surface to which a seal 20 (film material) is attached. (b) of FIG. 5 is a view illustrating a package 22 of any of the porous separator rolls 12U, 12L, and 12P in which package 22 any of the porous separator rolls 12U, 12L, and 12P is wrapped with a wrapping material 21. (c) of FIG. 5 is a view illustrating a package 24 in which a rack 23 and any of the porous separator rolls 12U, 12L, and 12P placed on the rack 23 are wrapped with a wrapping material 21. Note that the rack 23 is a rack for holding and transporting one or more of the porous separator rolls 12U, 12L, and 12P and can be provided with a plurality of wheels on its lower side as illustrated in (c) of FIG. 5.

Note that Embodiment 1 also relates to a method for storing a porous separator roll as each of the packages 22 and 24 in which any of the porous separator rolls 12U, 12L, and 12P is wrapped with the wrapping material 21 as illustrated in (b) of FIG. 5 and (c) of FIG. 5.

In the package of the porous separator roll in accordance with Embodiment 1, the entire porous separator roll does not need to be completely wrapped with the wrapping material. That is, a part which does not influence deterioration in quality of the porous separator roll does not need to be wrapped with the wrapping material. For example, in a case of the porous separator roll 12P into which the porous separator original sheet 12O is wound, end parts of the porous separator roll 12P in a winding axis direction are normally discarded by slitting, and therefore the end parts which are to be discarded do not need to be wrapped with the wrapping material. In other words, in the package of the porous separator roll in accordance with Embodiment 1, it is only necessary that at least a part, whose quality should not be deteriorated, is wrapped with the wrapping material.

The wrapping material in accordance with Embodiment 1 can include one (1) sheet or can include two or more sheets. In a case where a wrapping material is used in which two or more sheets are stacked, it is only necessary that an average transmittance of the stacked two or more sheets with respect to light having a wavelength of 360 nm to 390 nm is 25% or lower.

(Transmittance of Various Wrapping Material (Wrapping Box))

FIG. 6 is a view showing transmittances of various wrapping materials and the porous film 5 (i.e., the polyolefin porous base material in Embodiment 1) with respect to wavelengths. The transmittances of the various wrapping materials and the porous film 5 are obtained as follows: (i) light is adjusted with use of a light shielding material so that the wrapping material or the porous film 5 is irradiated with light of 4 mmφ, (ii) three locations of the wrapping material or the porous film 5 are measured with use of an ultraviolet and visible spectrophotometer UV-2450 (manufactured by Shimadzu Corporation) such that a part at which an amount of resin in the thickness direction is smallest becomes a center of measurement, and (iii) measurement results of the three locations are averaged.

Note that the various wrapping materials in FIG. 6 are items of the following item numbers manufactured by the following manufacturers. Sheet for transparent plastic corrugated cardboard (containing a UV absorbent): SGTCC-manufactured by Asahi Glass Co., Ltd.; Transparent buffering material: d37 manufactured by Kawakami Sangyo Co., Ltd.; Green buffering material: v-d37LG manufactured by Kawakami Sangyo Co., Ltd.; Brown buffering material: O-d37 manufactured by Kawakami Sangyo Co., Ltd.; Sheet for semi-transparent plastic corrugated cardboard: HP50100 (natural) manufactured by Sanei Siko Co., Ltd.

(Degrees of Change in Color of Porous Layers by Irradiation with UV Light when Various Wrapping Materials are Used)

FIG. 7 is a view showing a degree of change in color of porous layers by irradiation with UV light in a case where the laminated long separator sheet as the porous long separator sheets 12a and 12b, in each of which the porous film 5 and the aramid layer as the porous layer (heat-resistant layer 4) are laminated, is wrapped with any of the various wrapping materials.

The degrees of change in color of the porous layers by irradiation with UV light in a reference sample (reference 1), a sample 1, a sample 2, and a sample 3 are evaluated with use of values of ΔWI, ΔYI, WI, and YI.

ΔWI is a value defined by the following formula (1): ΔWI=WI₁−WI₀. Here, WI is a white index defined in E313 of American Standards Test Methods.

WI₀ (pre-process WI) is WI of a surface of the porous layer measured with a spectrophotometric colorimeter before the porous layer is irradiated with UV light of 255 W/m² (i.e., before starting irradiation with UV light of 255 W/m²). WI₁ (post-process WI) is WI of a surface of the porous layer measured with the spectrophotometric colorimeter after the porous layer has been irradiated with UV light of 255 W/m² for 75 hours.

ΔYI is defined by the following formula (2): ΔYI=YI₁−YI₀. Here, YI is a yellow index.

YI₀ (pre-process YI) is YI of a surface of the porous layer measured with the spectrophotometric colorimeter before the porous layer is irradiated with UV light of 255 W/m² (i.e., before starting irradiation with UV light of 255 W/m²). YI₁ (post-process YI) is YI of a surface of the porous layer measured with the spectrophotometric colorimeter after the porous layer has been irradiated with UV light of 255 W/m² for 75 hours.

In FIG. 7, WI is a value defined by the following formula (3): WI=(ΔWI_reference 1−ΔWI_sample). In a case where a value of WI is larger toward negative side, ΔWI is smaller than that of the reference sample (reference 1). That is, such a case means that a change in white index due to irradiation with UV light is smaller than that of the reference sample (reference 1).

In FIG. 7, YI is a value defined by the following formula (4): YI=(ΔYI_reference 1−ΔYI_sample). In a case where a value of YI is larger, ΔYI is smaller than that of the reference sample (reference 1). That is, such a case means that a change in yellow index due to irradiation with UV light is smaller than that of the reference sample (reference 1).

As shown in FIG. 7, a measurement result of the reference sample (reference 1) is obtained in a case where the porous layer of the laminated separator is irradiated with UV light while no wrapping material is placed on the porous layer. A measurement result of the sample 1 is obtained in a case where the porous layer of the laminated separator is irradiated with UV light from a transparent buffering material side while one (1) transparent buffering material is placed on the porous layer. A measurement result of the sample 2 is obtained in a case where the porous layer of the laminated separator is irradiated with UV light from a transparent buffering material side while two transparent buffering materials are placed on the porous layer. A measurement result of the sample 3 is obtained in a case where the porous layer of the laminated separator is irradiated with UV light from a brown buffering material side while one (1) brown buffering material is placed on the porous layer.

As shown in FIG. 7, average transmittances (%) in the cases of one (1) transparent buffering material, two transparent buffering materials, and one (1) brown buffering material at the wavelengths of 360 nm to 390 nm are 59.47%, 35.23%, and 0.73%, respectively. Moreover, average absorbances in the cases of one (1) transparent buffering material, two transparent buffering materials, and one (1) brown buffering material at the wavelengths of 360 nm to 390 nm are 0.23, 0.45, and 2.14, respectively.

As the spectrophotometric colorimeter, for example, an integrating sphere spectrophotometric colorimeter can be suitably used so as to easily and accurately measure WI and YI. The integrating sphere spectrophotometric colorimeter is a device which (i) irradiates a sample with light of a xenon lamp, (ii) collects reflected light from the sample to a light receiving section by an integrating sphere which surrounds the irradiated part, and (iii) carries out optical spectrometry. With use of the integrating sphere spectrophotometric colorimeter, it is possible to measure various optical parameters. Note, however, that the spectrophotometric colorimeter is not particularly limited to the integrating sphere spectrophotometric colorimeter and can be any spectrophotometric colorimeter which can measure WI and YI. In Embodiment 1, WI of the separator is measured with use of a spectrophotometric colorimeter (CM-2002, manufactured by KONICA MINOLTA, INC.) under condition of Specular Component Include (SCI). In this case, WI is measured while using a black paper (manufactured by Hokuetsu Kishu Paper Co., Ltd., high-quality colored paper, black, thickest, paper size: 788 mm×1091 mm, grain long) as an underlay of the separator.

The “surface of the porous layer” indicates a part of the porous layer which part receives light emitted from the spectrophotometric colorimeter. WI and YI of the surface of the porous layer can be measured by the spectrophotometric colorimeter in accordance with an instruction manual of the spectrophotometric colorimeter and the measurement method is not limited to a particular one. For example, it is preferable that the porous layer is irradiated with light while being placed on a black paper so that reflected light from the porous layer can be easily collected at the light receiving section of the spectrophotometric colorimeter.

It is preferable that irradiation with the UV light of 255 W/m² is carried out with use of a device which can carry out continuous UV light irradiation. For example, it is possible to use a lightfastness testing machine or a weatherability testing machine defined in JIS B 7753 (e.g., Sunshine Weather Meter S80 manufactured by Suga Test Instruments Co., Ltd.). The UV light irradiation is carried out by irradiating a test piece with light by a sunshine carbon arc (four pairs of ultra-long life carbon) light source for 75 hours under the following conditions: a discharging voltage is 50 V, a discharging current is 60 A, a black panel temperature is 60° C., and a relative humidity is 50%.

FIG. 8 is a view showing a degree of change in color of porous layers by irradiation with UV light in a case where the laminated long separator sheet as the porous long separator sheets 12a and 12b, in each of which the porous film 5 and the aramid layer as the porous layer (heat-resistant layer 4) are laminated, is wrapped with any of other various wrapping materials.

The degrees of change in color of the porous layers by irradiation with UV light in a reference sample (reference 2) and samples 4 through 8 are evaluated with use of values of ΔWI, ΔYI, WI, and YI.

As shown in FIG. 8, a measurement result of the reference sample (reference 2) is obtained in a case where the porous layer of the laminated separator, which is in a production lot different from that of the reference sample (reference 1), is irradiated with UV light while no wrapping material is placed on the porous layer.

A measurement result of the sample 4 is obtained in a case where the porous layer of the laminated separator is irradiated with UV light from a side of sheet for semi-transparent plastic corrugated cardboard while two sheets for semi-transparent plastic corrugated cardboard are placed on the porous layer. A measurement result of the sample 5 is obtained in a case where the porous layer of the laminated separator is irradiated with UV light from a side of sheet for transparent plastic corrugated cardboard while one (1) sheet (having a thickness of 4 mm and containing a UV absorbent) for transparent plastic corrugated cardboard is placed on the porous layer. A measurement result of the sample 6 is obtained in a case where the porous layer of the laminated separator is irradiated with UV light from a side of sheet for transparent plastic corrugated cardboard while two sheets (having a thickness of 4 mm×2 and containing a UV absorbent) for transparent plastic corrugated cardboard are placed on the porous layer. A measurement result of the sample 7 is obtained in a case where the porous layer of the laminated separator is irradiated with UV light from a green buffering material side while one (1) green buffering material is placed on the porous layer. A measurement result of the sample 8 is obtained in a case where the porous layer of the laminated separator is irradiated with UV light from a green buffering material side while two green buffering materials are placed on the porous layer.

As shown in FIG. 8, average transmittances (%) in the cases of two sheets for semi-transparent plastic corrugated cardboard, one (1) sheet for transparent plastic corrugated cardboard, two sheets for transparent plastic corrugated cardboard, one (1) green buffering material, and two green buffering materials at the wavelengths of 360 nm to 390 nm are 0.04%, 5.64%, 1.17%, 25.78%, and 8.99%, respectively. Moreover, average absorbances in the cases of two sheets for semi-transparent plastic corrugated cardboard, one (1) sheet for transparent plastic corrugated cardboard, two sheets for transparent plastic corrugated cardboard, one (1) green buffering material, and two green buffering materials at the wavelengths of 360 nm to 390 nm are 3.45, 1.25, 1.93, 0.59, and 1.05, respectively.

Note that, in a case where the porous layer of the laminated separator is partially changed in color, an amount of transmitted light or an amount of reflected light at a particular wavelength changes when, in particular, an optical testing device and a control device are used. This may lead to erroneous detection in measuring a weight per unit area or measuring a film location.

(a) of FIG. 9 is a view showing a relation between a value of WI of a porous layer and an absorbance of a wrapping material in each of samples. (b) of FIG. 9 is a view showing a relation between a value of WI of a porous layer and a transmittance of a wrapping material in each of samples.

In a case where a value of WI is larger toward negative side, ΔWI is smaller than that of the reference sample (reference 1 or 2). That is, such a case means that a change in white index due to irradiation with UV light is smaller than that of the reference sample (reference 1 or 2).

As shown in (a) of FIG. 9, in a case where an average absorbance of the wrapping material with respect to light having a wavelength of 360 nm to 390 nm is 0.3 or more, the value of WI of the porous layer is relatively large toward negative side. From this, as the wrapping material, it is possible to use a wrapping material whose average absorbance with respect to light having a wavelength of 360 nm to 390 nm is 0.3 or more. Moreover, in a case where the average absorbance is near to 0.8, the value of WI of the porous layer notably decreases, and it is therefore preferable to use a wrapping material whose average absorbance with respect to light having a wavelength of 360 nm to 390 nm is 0.8 or more.

Moreover, as shown in (b) of FIG. 9, in a case where an average transmittance of the wrapping material with respect to light having a wavelength of 360 nm to 390 nm is 50% or lower, the value of WI of the porous layer is relatively large toward negative side. From this, as the wrapping material, it is possible to use a wrapping material whose average transmittance with respect to light having a wavelength of 360 nm to 390 nm is 50% or lower. That is, the package in accordance with an aspect of the present invention can be a package in which a porous separator roll obtained by winding a porous long separator sheet on a core is wrapped with a wrapping material whose average transmittance with respect to light having a wavelength of 360 nm to 390 nm is 50% or lower. Moreover, in a case where the average transmittance is near to 25%, the value of WI of the porous layer notably decreases, and it is therefore preferable to use a wrapping material whose average transmittance with respect to light having a wavelength of 360 nm to 390 nm is 25% or lower.

(a) of FIG. 10 is a view showing a relation between a value of YI of a porous layer and an absorbance of a wrapping material in each of samples. (b) of FIG. 10 is a view showing a relation between a value of YI of a porous layer and a transmittance of a wrapping material in each of samples.

In a case where a value of YI is larger, ΔYI is smaller than that of the reference sample (reference 1 or 2). That is, such a case means that a change in yellow index due to irradiation with UV light is smaller than that of the reference sample (reference 1 or 2).

As shown in (a) of FIG. 10, in a case where an average absorbance of the wrapping material with respect to light having a wavelength of 360 nm to 390 nm is 0.3 or more, the value of YI of the porous layer is relatively large. From this, as the wrapping material, it is possible to use a wrapping material whose average absorbance with respect to light having a wavelength of 360 nm to 390 nm is 0.3 or more. Moreover, in a case where the average absorbance is near to 0.8, the value of YI of the porous layer notably increases, and it is therefore preferable to use a wrapping material whose average absorbance with respect to light having a wavelength of 360 nm to 390 nm is 0.8 or more.

Moreover, as shown in (b) of FIG. 10, in a case where an average transmittance of the wrapping material with respect to light having a wavelength of 360 nm to 390 nm is 50% or lower, the value of YI of the porous layer is relatively large. From this, as the wrapping material, it is possible to use a wrapping material whose average transmittance with respect to light having a wavelength of 360 nm to 390 nm is 50% or lower. That is, the package in accordance with an aspect of the present invention can be a package in which a porous separator roll obtained by winding a porous long separator sheet on a core is wrapped with a wrapping material whose average transmittance with respect to light having a wavelength of 360 nm to 390 nm is 50% or lower. Moreover, in a case where the average transmittance is near to 25%, the value of YI of the porous layer notably decreases, and it is therefore preferable to use a wrapping material whose average transmittance with respect to light having a wavelength of 360 nm to 390 nm is substantially 25% or lower in a most part of an exposed area of the wrapping material.

By using such a wrapping material, it is possible to inhibit change in color which change reaches an inner peripheral part of the porous long separator sheet 12a or 12b or the porous separator original sheet 12O and can be caused due to the seal 20 (film material) that is attached to an outer peripheral surface of the porous long separator sheet 12a or 12b or the porous separator original sheet 12O in the porous separator roll 12U, 12L, or 12P illustrated in (a) of FIG. 5.

Note that, in the porous separator rolls 12U and 12L, the porous long separator sheets 12a and 12b are wound so that the surface A (which is opposite to a surface of the porous film 5 (i.e., polyolefin porous base material in Embodiment 1) which surface makes contact with the heat-resistant layer 4) of each of the porous long separator sheets 12a and 12b faces an outer side, and the surface B (which is opposite to a surface of the porous layer (i.e., heat-resistant layer 4) which surface makes contact with the porous film 5) faces an inner side (see (b) of FIG. 4).

As shown in (a) and (b) of FIG. 6, the porous film 5 (polyolefin porous base material) allows UV light to pass through while weakening the UV light. Therefore, in a case where a resin (e.g., a polymer containing halogen atoms or an aromatic polymer), which is more likely to be changed in color by UV light as compared with the porous film 5, is used as the porous layer, it is possible to further inhibit change in color of the porous layer (heat-resistant layer 4) by employing porous separator rolls 12U and 12L into which the porous long separator sheets 12a and 12b are wound so that the surface A of each of the porous long separator sheets 12a and 12b faces the outer side and the surface B of each of the porous long separator sheets 12a and 12b faces the inner side.

[Main Points]

In the package of a porous separator roll in accordance with an aspect 1 of the present invention, the porous separator roll which is obtained by winding a porous long separator sheet on a core is wrapped with a wrapping material whose average transmittance with respect to light having a wavelength of 360 nm to 390 nm is 25% or lower.

According to the configuration, it is possible to inhibit change in color, deterioration, and the like of the porous long separator sheet.

In the package in accordance with an aspect 2 of the present invention, it is preferable in the aspect 1 that the wrapping material has an average transmittance which is 10% or lower with respect to light having a wavelength of 360 nm to 390 nm.

According to the configuration, it is possible to inhibit change in color of the porous long separator sheet more efficiently.

In the package in accordance with an aspect 3 of the present invention, it is preferable in the aspect 1 that the wrapping material has an average absorbance which is 0.8 or more with respect to light having a wavelength of 360 nm to 390 nm.

According to the configuration, it is possible to inhibit change in color of the porous long separator sheet more efficiently.

In the package in accordance with an aspect 4 of the present invention, it is preferable in any of the aspects 1 through 3 that a film material is attached to an outer peripheral surface of the porous long separator sheet in the porous separator roll.

According to the configuration, it is possible to inhibit change in color which change reaches an inner peripheral part of the porous long separator sheet and can be caused due to the film material that is attached to an outer peripheral surface of the porous long separator sheet.

In the package in accordance with an aspect 5 of the present invention, it is possible in any of the aspects 1 through 4 that the porous long separator sheet is a laminated long separator sheet in which a polyolefin porous base material and a porous layer are laminated.

According to the configuration, it is possible to provide a package of a porous separator roll including a laminated long separator sheet.

In the package in accordance with an aspect 6 of the present invention, it is possible in the aspect 5 that the porous layer contains a polymer containing halogen atoms or an aromatic polymer.

According to the configuration, it is possible to provide a package of a porous separator roll which includes a porous long separator sheet having a porous layer that contains a polymer containing halogen atoms or an aromatic polymer.

In the method in accordance with an aspect 7 of the present invention for storing a porous separator roll, the porous separator roll is stored in a form of a package of a porous separator roll described in any of the aspects 1 through 6.

According to the method, it is possible to inhibit change in color, deterioration, and the like of the porous long separator sheet included in the porous separator roll.

The method in accordance with an aspect 8 of the present invention for producing a package of a porous separator roll is a method including the step of wrapping the porous separator roll, which is obtained by winding a porous long separator sheet on a core, with a wrapping material whose average transmittance with respect to light having a wavelength of 360 nm to 390 nm is 25% or lower.

According to the method, it is possible to produce a package of a porous separator roll which can inhibit change in color, deterioration, and the like of the porous long separator sheet included in the porous separator roll.

[Additional Remarks]

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### INDUSTRIAL APPLICABILITY

The present invention is applicable to a separator roll and the like which are used in batteries such as a lithium-ion battery.

### REFERENCE SIGNS LIST

1: Lithium-ion secondary battery
4: Heat-resistant layer (porous layer)
5: Porous film
6: Slitting apparatus
7: Cutting device
12: Porous separator
12a: Porous long separator sheet
12b: Porous long separator sheet
12U: Porous separator roll
12L: Porous separator roll
12O: Porous separator original sheet
12P: Porous separator roll
20: Seal (film material)
21: Wrapping material
22: Package of porous separator roll
23: Rack
24: Package of porous separator roll
l: Core
u: Core
c: Core
MD: Machine direction of long separator sheet or separator original sheet
TD: Transverse direction of long separator sheet or separator original sheet
Surface A: Surface of porous film which surface is opposite to a surface contacting with heat-resistant layer
Surface B: Surface of heat-resistant layer which surface is opposite to a surface contacting with porous film

1. A package of a porous separator roll, wherein:
the porous separator roll which is obtained by winding a porous long separator sheet on a core is wrapped with a wrapping material whose average transmittance with respect to light having a wavelength of 360 nm to 390 nm is 25% or lower.

2. The package as set forth in claim 1, wherein:
the wrapping material has an average transmittance which is 10% or lower with respect to light having a wavelength of 360 nm to 390 nm.

3. The package as set forth in claim 1, wherein:
the wrapping material has an average absorbance which is 0.8 or more with respect to light having a wavelength of 360 nm to 390 nm.

4. The package as set forth in claim 1, wherein:
a film material is attached to an outer peripheral surface of the porous long separator sheet in the porous separator roll.

5. The package as set forth in claim 1, wherein:
the porous long separator sheet is a laminated long separator sheet in which a polyolefin porous base material and a porous layer are laminated.

6. The package as set forth in claim 5, wherein:
the porous layer contains a resin having a n bonding or halogen atoms.

7. A method for storing a porous separator roll, wherein:
the porous separator roll is stored in a form of a package of a porous separator roll recited in claim 1.

8. A method for producing a package of a porous separator roll, said method comprising the step of:
wrapping the porous separator roll, which is obtained by winding a porous long separator sheet on a core, with a wrapping material whose average transmittance with respect to light having a wavelength of 360 nm to 390 nm is 25% or lower.
